(19) United States
(12) Patent Application Publication
(10) Pub. No.: US 2002/0056102 A1
(43) Pub. Date: May 9, 2002

(54) Personal video on-demand system and method

(75) Inventors: Douglas Dillon, Gaithersburg, MD (US); Sam Baumel, Rockville, MD (US); Michael Ficco, Silver Spring, MD (US); Jeff Singer, Gaithersburg, MD (US); Robert Davis, Woodbine, MD (US)

Correspondence Address: Hughes Electronics Corporation, Patent Docket Administration, Bldg. 1, Mail Stop A109, P.O. Box 956, El Segundo, CA, 90245-0956, US

(73) Assignee: HUGHES ELECTRONICS CORPORATION

(21) Appl. No.: 09/766,252

(22) Filed: Jan. 19, 2001

Related U.S. Application Data
(63) Continuation-in-part of application No. 09/533,843, filed on Mar. 23, 2000.
(60) Provisional application No. 60/235,229, filed on Sep. 26, 2000.

(51) Int. Cl. G06F 3/00

(52) U.S. Cl. 725/39

(57) ABSTRACT

A personalized video-on-demand system and method utilizes an array of hard disk drives or other storage media to create a video server farm having the enormous capacity necessary for a video content library. A content feed supplies video content to the inventive device via a variety of communication media. Utilizing the device, the content stream may be directly viewed, decoded/decrypted or recorded in the video server farm. A multiple receiver/tuner can receive multiple content streams and the system may simultaneously record a plurality of programs on a storage device. With a multiple display unit such as a picture-in-picture television, the consumer can view desired programs in the normal manner while the device aggregates a video library in the background. An electronic program guide aids in the content selection and recording. Scheduling conflicts are resolved by simultaneous, multiple recording methods. The content provider may also add tags to the video content which contain information associated with the content such as actors, director, synopsis, keywords. By utilizing selection criteria, the electronic program guide can access these tags to determine desired content for the video library. Furthermore, audio and/or data may be aggregated by the invention for on-demand playback or manipulation. A file manager assists in the creation of a database of recorded content. The file manager enables manipulation of the database including the addition and delete of entries, the annotation of entries, and searching based on information contained in the entries. A printer may also be utilized to print physical labels, which may be secured to individual storage media.

### CROSS REFERENCE TO A RELATED APPLICATION

This application is a continuation-in-Part and claims benefit under 35 U.S.C. §120 of U.S. Non-Provisional application of Michael Ficco et al entitled “Personal Video On-Demand System and Method”, Ser. No. 09/533,843 filed on Mar. 23, 2000, the entire contents of which is incorporated by reference herein. This application also claims benefit under 35 U.S.C. §119(e) of U.S. Provisional application of Douglas Dillon et al entitled “Digital Recording Settop Box with Removable Media and Electronic Catalog”, Ser. No. 60/235,229 filed on Sep. 26, 2000, the entire contents of which is also incorporated by reference herein.

### BACKGROUND OF THE INVENTION

1. Field of the Invention

The present invention generally relates to audio and video devices. The present invention more specifically relates to the field of video-on-demand equipment and services.

2. Background of the Prior Art

Providing video-on-demand has been a elusive goal sought after by a variety of companies. Many of the efforts to date have been stymied by the enormous bandwidth consumed when a large number of movies or other content are requested by individuals. This problem is exacerbated when an insufficient number of consumers request a particular movie such that it is not economically justified to consume the available bandwidth for such a small number of requests. In order to be profitable, conventional video-on-demand services offer only the most popular movies. The result is that the most attractive feature of video-on-demand is destroyed. This most attractive feature is the availability of a wide variety of movies or other content on demand of a consumer.

Various other problems exist in conventional video-on-demand services including inconvenient and limited ways in which to designate desired content.

Another shortcoming of conventional video-on-demand services is the inability to aggregate a video library in a fast and efficient manner. Other problems include the negative impact of aggregating a video library on the normal viewing habits of the consumer.

### SUMMARY OF THE INVENTION

An object of the present invention is to remedy the above-noted deficiencies in conventional video-on-demand services and equipment. Another object is to enable video-on-demand equipment with a capacity large enough to accommodate potentially desired content. Yet another object of the invention is to provide an expandable storage device that can be easily added to by a consumer thereby increasing the capacity for the personal video library. Another object of the invention is to provide simultaneous recording of two or more programs to most efficiently build the video-on-demand library. Yet another object is to provide simultaneous playing back of a first program while another is being simultaneously recorded.

One aspect of achieving the above object is to utilize an array of hard disk drives to create a video server farm. Such a video server farm provides the enormous capacity necessary for an adequate content library while also providing an expandable storage space.

The invention creates a new paradigm for video-on-demand services in which a video server farm is utilized in combination with an electronic program guide and associated receiver, tuner, control unit, and user interface that enables a consumer to create his own, personal video-on-demand library.

More specifically, the present invention includes a content feed that provides a variety of content or broadcast television programs from numerous transmission media to, for example, a set-top box or other apparatus. The invention includes a receiver/tuner that receives the content stream from the content feed and routes the content stream to a display unit, a decoder/decrypter or to a storage device in response to a control signal from a control unit. In this way, the content stream may be directly viewed as in a conventional cable box or decoded/decrypted before being viewed by a display unit. Another route provided by the invention is to a storage device so that selected content may be recorded.

To aid in the selection of desired content, an electronic program guide is utilized. This electronic program guide receives programming information for available content that will be broadcast to the inventive apparatus in the future. With a user interface device, the user can interact with the electronic program guide and select the desired programs that will be recorded on the storage device. Enhanced functionality for the electronic program guide includes the ability to track previously selected content so that identical or similar programs can be recorded in the future. Other enhancements include inputting selection criteria such as actor, director, theme, keywords, channel information, station call letters, etc. which can be utilized by the control unit to search the electronic program guide for content matching the consumer's criteria.

Preferably, the storage device is expandable and/or removable such that the user can easily add and/or remove additional storage capacity as desired or needed. For example, the storage device may include magnetic tape, magnetic or optical disk (for example, a read/write disk or a write once/read many disk), CD, DVD, of a portable digital audio/video/data player.

Further enhancements to the present invention include the ability to transcode from one medium type to another to ensure efficient storage, regardless of the target medium. Transcoding may include using different compression techniques or different sets of compression parameters for the same compression technique.

Further enhancements to the present invention include a file manager for the creation and management of a database, which includes an entry for each program recorded. The file manager further supports other database manipulation operations, such as adding, deleting, searching, etc. The file manager also enables the user to print a physical label that may be attached to storage media. The file manager also permits annotation of the database entry for each program recorded. The information contained in these annotations may be supplied electronically, such as via an electronic program guide or may be manually generated by a user.

Further enhancements to the present invention include the use of internal and external memory in combination. This enables the present invention to record program information to internal memory and then to external memory or to stream program information directly to external memory. The combination of internal and external also permits recording from removable memory into internal memory and then ultimate playback from the internal memory.

Further enhancements to the present invention include a multiple receiver/tuner embodiment in which multiple content streams can be received, tuned and provided to the storage device. With a plurality of receiver/tuners, this modification has the ability to simultaneously record a plurality of programs on a storage device. A multiple display unit such as a picture-in-picture television can be utilized to simultaneously view the two programs being recorded. Alternatively, one program can be recorded while another is being viewed either from a live broadcast or from the previously recorded video library in the storage unit.

The invention also includes a method of determining potentially desired content which includes manually inputting content selection(s) and selection criteria. As mentioned above, the selection criteria may include a variety of criteria such as actor, program name, director, keywords, channel information, station call letters, etc. Such selection criteria may be utilized in conjunction with tagged content in which the content stream is tagged with additional information associated with the content. For example, a typical tag may include which actors star in the program, the director, a synopsis, keywords, a thumbnail, a preview, a snippet, etc. The tags may be in-band or otherwise transmitted along with the content or associated with the program and sent separately such as with an electronic program guide. In any of these alternatives, the selection criteria may be utilized to search through these tags for potentially desired content.

Furthermore, the methods of the invention track previously selected content and previously utilized selection criteria in order to learn the consumers preferences. This tracked information is then added to the selection of potentially desired content so that the appropriate content may be recorded by the inventive apparatus.

The method of operating the inventive apparatus may also include downloading the electronic program guide on a periodic basis. Selections and criteria may then be inputted. The electronic program guide is then scanned for content matching the selections and/or input criteria. If a match is found, then a broadcast channel is tuned and the content output to the storage device. Appropriate changes are made to a file manager to keep track of the recorded content. Thereafter, the consumer can manage the recorded content by, for example, deleting, sorting, cataloging, commenting, etc.

On the content provider side, the electronic program guide may be compiled and uploaded to the user. Because different regions of the country have different available channels, the program listings may be winnowed to only those available to the particular consumer. Tags can then be generated that describe or otherwise indicate the program content and these tags are associated with the program listings.

The inventive methods also include simultaneous recording of multiple content streams. After scanning the electronic program for content matching the consumer's preferences, the invention determines whether there are scheduling conflicts. Such scheduling conflicts are resolved by multiple, simultaneous recording of plural content streams.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a personalized video-on-demand system according to a first aspect of the invention;

FIG. 2 is a block diagram of a personalized video-on-demand system according to a second aspect of the invention;

FIG. 3 is a high-level flow chart of the inventive method of determining potentially desired content;

FIG. 4 is a high-level flow chart of a method of creating a video-on-demand service;

FIG. 5 is a high-level flow chart of a method of generating an electronic program guide according to the invention; and

FIG. 6 is a high-level flow chart of a method of creating a personalized video-on-demand service capable of simultaneous, multiple recording of plural content streams.

### DETAILED DESCRIPTION OF PREFERRED EMBODIMENTS

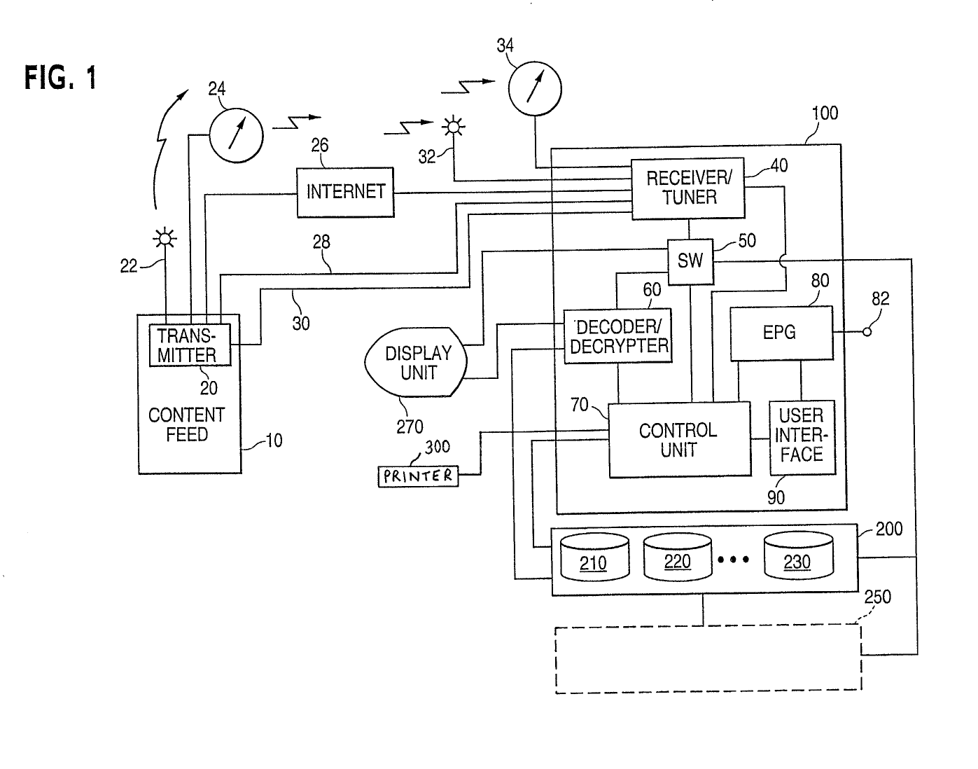

As shown in FIG. 1, the personalized video-on-demand system includes a content feed 10. This content feed 10 may include a broadcast television network or internet content provider. The content feed is compatible with all cable, satellite and terrestrial broadcast television systems as indicated by transmitter 20 that is connected to a broadcast antenna 22, satellite up-link 24, internet connection 26, cable 28, and phone line 30. These various connections and standards are exemplary only and are intended to include any system for feeding content to a consumer.

On the consumer side, an apparatus 100 such as a set-top box, hardware card, specially programmed computer or other device having the functionality described herein is provided that may be placed near to or within a television or other display device (such as a computer monitor) such as display unit 270. The apparatus 100 inputs content from devices such as satellite down-link 34, antenna 32, internet connection 26, cable 28, and/or phone line 30. It is to be understood that the apparatus 100 may include just a single communication path including 26, 28, 30, 32, or 34.

The received content is fed to receiver/tuner 40. The receiver/tuner 40 provides an appropriate connection to the corresponding communication path. The receiver/tuner 40 may also select or tune a channel within the spectrum of content being fed to the apparatus 100. If there is only one channel, then the receiver unit 40 need not include a tuner circuit.

A switch 50 is connected to the receiver/tuner 40 and routes the content to display unit 270, decoder/decrypter 60, or storage device 200. The switch 50 is controlled by control unit 70 to route the content to the desired destination.

The decoder/decrypter 60 includes decoder circuitry and/or decryption circuitry. For example, many video broadcasts are encoded and the decoder 60 decodes this encoded content stream so that it may be viewed by the consumer on display unit 270. Conventional decoding processes such as MPEG1 and MPEG2 are examples of such decoding processes.

The component 60 may also include decryption circuitry that decrypts an encrypted content from the content feed. Some broadcasts, particularly pay-per-view broadcasts or premium channels such as HBO® and Showtime® are encrypted so that non-subscribers cannot view the content. The decrypter 60 decrypts any such encrypted content for viewing on the display unit 270 by the consumer. The decrypter may include a variety of decryption schemes for corresponding premium channels or services. As with conventional cable boxes, the decryption circuitry may be enabled or disabled depending upon the consumer's subscription to the premium channel or associated encrypted content. Authorization for decryption may be governed by appropriate payment for the associated content. For example, pay-per-view content is typically encrypted with decryption authorization governed by an appropriate payment by the consumer.

As a further alternative, the decrypted content may be stored for later purchase and playback. In this alternative, the consumer need not pay in advance or contemporaneous with the live broadcast and can, instead, store the encrypted content for later playback. Such delayed playback may also include an associated payment if required by the content provider by utilizing the user interface 90 and communication channel(s) with content feed 10 or by having the consumer contact the content provider using other communication channels and payment mechanisms.

The component 60 may also implement an encryption scheme separate from and/or in addition to the encryption scheme utilized by the content feed 10. In other words, encrypted content supplied from content feed may be further encrypted to further protect unauthorized access to the content.

The electronic program guide (EPG) 80 is connected to an input port 82 so that updates to the electronic program guide may be downloaded. In other words, the electronic program guide stores available content for the near future. This available content may be updated on a periodic basis so that the consumer can make appropriate selection for upcoming programs. The electronic program guide 80 preferably displays information on the display unit 270. For example, the electronic program guide 80 may display programs in a tabular format by channel and time so that the user can make selections of desired content. Other examples and functionality of the electronic program guide 80 are described below.

The user interface 90 may include various control devices such as a keypad connected directly to the apparatus 100 or a remote control device. The user interface 90 permits the user to interact with the apparatus 100 and electronic program guide 80 and thereby select content for recording and on-demand playback.

The storage device 200 is connected to the switch 50 as well as the control unit 70 and the decoder/decrypter 60. The storage device 200 may also be directly connected to the display unit 270. The storage device 200 may include a plurality of hard disk drives 210, 220, 230 as shown in FIG. 1. Also, the storage device 200 may include only one hard disk drive although the storage capacity would be necessarily limited by the capacity of the single hard disk drive 210.

Preferably, the storage device may be expanded by plugging in additional hard disk drives such as hard disk drive 220 as well as hard disk drive 230. Preferably, adding storage capacity could be easily accomplished by the user by simply plugging in a storage device such as a hard disc drive. The collection of hard disk drives 210, 220 . . . 230 may also be considered a hard disk drive array. Such an array may use conventional data loss prevention methods such as error correcting codes, and Redundant Array of Independent Discs (RAID) methodologies.

The storage device 200 may be further expanded by adding an optional array of hard disk drives 250 as shown by the dotted lines in FIG. 1. The storage devices 200, 250 may be provided in a separate unit from apparatus 100.

Alternatively, the storage device 200 may include other types of storage devices. For example, the storage device may include solid state memory devices such as chips, cards, or sticks. The storage device may also include magnetic tape, magnetic or optical disk (for example, a read/write disk or a write once/read many disk), CD, DVD, a portable digital audio/video/data player, a jukebox, or any other known or not yet invented form of storage. The jukebox may include a mixture of blank and recorded media, for example, at least one blank medium for recording and at least one recorded medium for playback.

The storage device further may be reconfigurable, including, as examples, expandable, addable, removable, and/or replaceable. The storage device may be manually reconfigurable or automatically reconfigurable. For example, a user may replace all or part of the storage device. Alternatively, the storage device may be configured as a “juke-box” including a plurality of memory devices 210, 220, 230 (either of the same or different types), which are automatically loaded for recording or playback, possibly based on a user initiated request. The memory devices 210, 200, 230 may be integrated with the storage device 200 and/or the apparatus 100 or accessible via a network (either local or wide-area) utilizing a transfer protocol (for example, the 1394 protocol) or a combination of integrated and removable memory. Preferably, the memory devices 210, 220, 230 may be plugged in or otherwise expanded with a modular design. This modular design is indicated in FIG. 1 by the plurality of storage devices 210, 220, 230 as well as the additional array of storage devices 250. Such a modular design permits a user to easily increase the storage capacity and thereby the size of the video-on-demand library.

The control unit is connected to the storage devices 200, 250, the decoder/decrypter 60, the switch 50, the receiving device 40, the electronic program guide 80, as well as the user interface 90.

In general, the control unit 70 coordinates all of the operations performed by the apparatus 100 by sending appropriate control signals to each of the various components. For example, when the electronic program guide indicates that the desired content will appear on channel 7 at 8:00 pm, the control unit 70 sends a control signal to receiver/tuner 40 to tune channel 7 at 8:00 pm, then control unit 70 sends a control signal to control switch 50 to switch the tuned content and output the tuned content to the storage device 200. The control unit 70 also controls the recording of this content on the storage device 200. For example, the control unit 70 may synchronize the sending/receiving of data between the storage device 200 and the control unit 70, in order to avoid periods of inaccessibility. For example, if one of the memory devices 210, 220, 230 is being removed or otherwise not available, the control unit 70 controls via synchronization, recording and/or playback, such that during the period of inaccessibility, the memory device 210, 220, 230 is not accessed. The control unit 70 may accomplish synchronization by sending a sync pulse to a storage device 200 and/or memory devices 210, 220, 230, in order to coordinate the availability of the memory devices 210, 220, and 230, with the operation desired by the control unit 70. Any necessary decoding or decryption is controlled by control unit 70 which sends commands to the decoder/decrypter the output of which is sent to display unit 270. The control unit 70 may also be utilized to control the rate at which information is recorded or played back. For example, the control unit 70 may record on a first medium, for example an internal medium, in real time, and then stream the information to a removable medium, either faster or slower than real time, depending on the capabilities of the removable medium. Similarly, the control unit 70 may permit the playback of information from either an internal or external memory, either faster or slower than real time, and subsequently output the data for playback in real time. The control unit 70 may utilize one or more medium to vary the rate at which content is either played back or recorded by utilizing at least one medium as a buffer.

The control unit 70 also coordinates the operations between the user interface 90 and the electronic program guide 80. For example, the on-demand playback of previously recorded content may be controlled with the user interface 90 by having the consumer input a command. This command is input by the control unit 70. For example, a play previously-recorded content number 7 may be input by user interface 90. This command is sent to control unit 70 which activates the storage device 200 to read the corresponding content from the storage device 200. Any necessary decoding is then performed by decoder 60 under the control of control unit 70 the results of which are output to display unit 270.

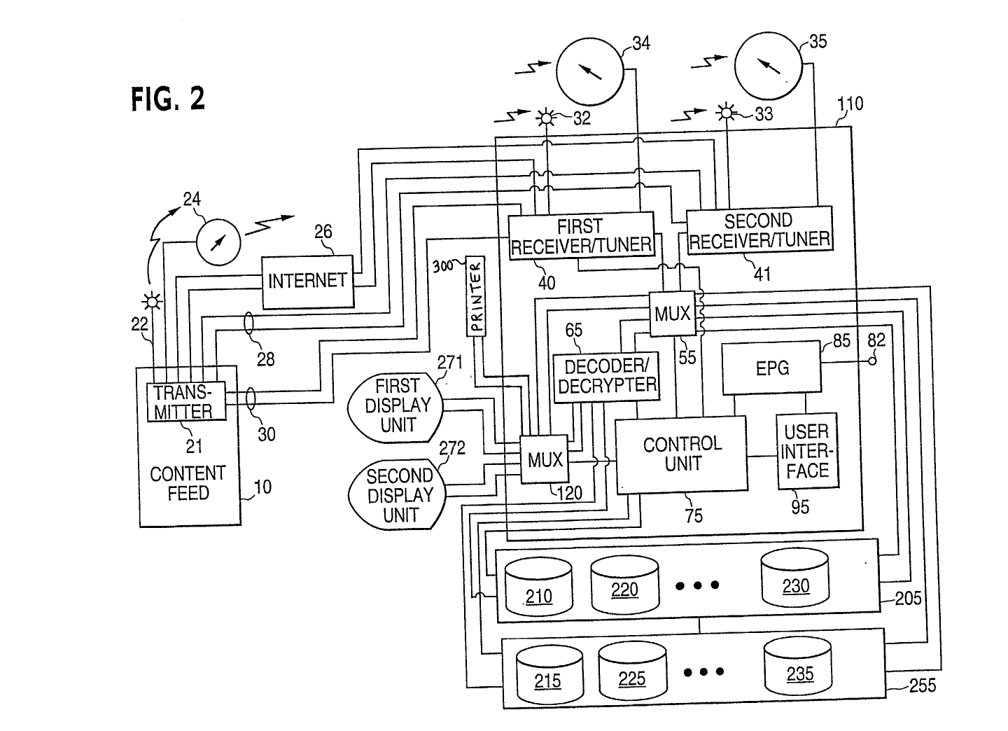

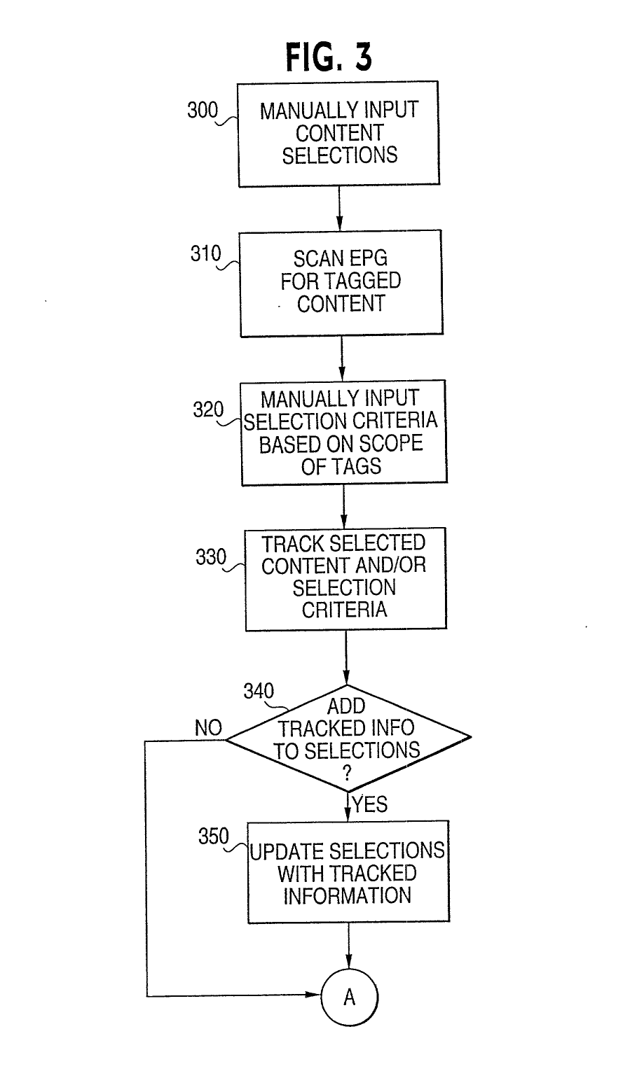

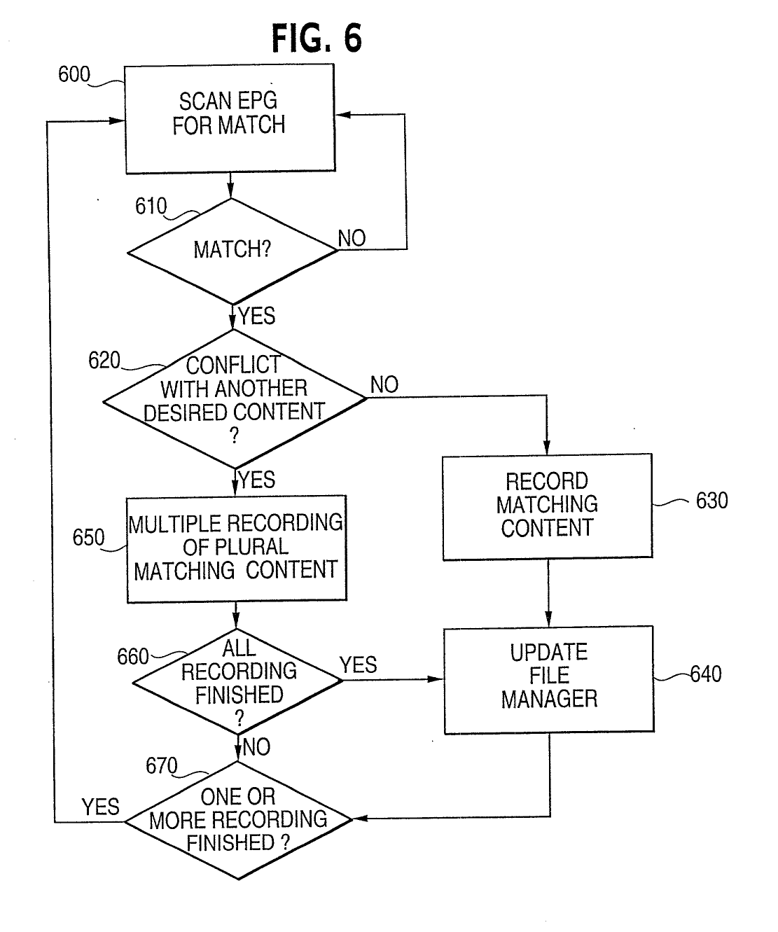

Although the system operates generally as described above, further details of the operation including both the provider and consumer side of the system are described below in relation to the flow charts of FIGS. 3-5. The flow chart of FIG. 6 further describes the operation of the system shown in FIG. 2.

FIG. 3 illustrates a particular example of how the FIG. 1 personal video-on-demand system operates. Specifically, FIG. 3 provides details on how the electronic program guide 80 interacts with the system.

As shown in FIG. 3, the consumer can manually input content selections in step 300. This may be done with the user interface 90. To aid in this process, the electronic program guide 80 may send a display to display unit 270 that aids in the manual input of content selections. In this way, the consumer can designate or otherwise select certain programs or other content to be recorded in the video-on-demand library. Step 300 may also delete previously selected content. In this way, the list of content selections may be tailored to the user's preferences.

Enhancing the electronic program guide 80 are tags. A tag includes data that is associated with or otherwise describes content. For example, a tag may indicate which actors are in a particular movie, the director of the movie, a synopsis of the movie, when it was released, critical reviews of the movie, related programs, sequels, keywords, a thumbnail, a preview, a snippet, or other information concerning or relating to the content. The tags may be in-band or otherwise transmitted along with the content. Alternatively, the tags may be associated with the program or otherwise sent separately such as with an electronic program guide.

Step 310 scans the electronic program guide 80 for content that has been tagged. In other words, step 310 searches or scans through the electronic program guide 80 for any content that has an associated tag. This enables step 310 to manually input selection criteria. These selection criteria are preferably based on the scope of the tags. In other words, if the tags are limited to actors and actresses, then the selection criteria may be similarly limited since other criteria would not effect the content selection. In this way, the user can manually input one or more selection criteria in order to search for desired content. This search may return a list or group of programs all of which may be recorded or which may be provided to the user for selection where only the selected content is recorded. This selection may be done by repeating step 300.

To further enhance the electronic program guide, step 320 tracks selected content and/or selection criteria. In other words, previously selected content may be tracked or otherwise stored by the control unit by the storage device 200. Also, previously input selection criteria may also be tracked or otherwise stored by the control unit 70 in the storage device 200. By tracking selected content and/or selection criteria, the electronic program guide 80 may learn the user's preferences and thereby speed the content selection process.

However, the consumer may not desire this tracking to be utilized. Thus, step 340 decides whether the consumer wants to add the tracked information to the selection. This may be done, for example, by prompting the user and inputting a command via the user interface 90. As another option, a default option may be utilized to make the decision of step 340.

If the tracked information is to be added to the selections, then step 350 is performed which updates the selections with the tracked information. In this way, a variety of content selections appropriate to and personalized to the consumer can be generated. The selection may be further managed by rearranging, deleting or by adding further selection by repeating the process shown in FIG. 3. The selection(s) may be presented to the user for modification(s). Alternatively, the system may simply retrieve the selections without user modification(s) to the selection(s).

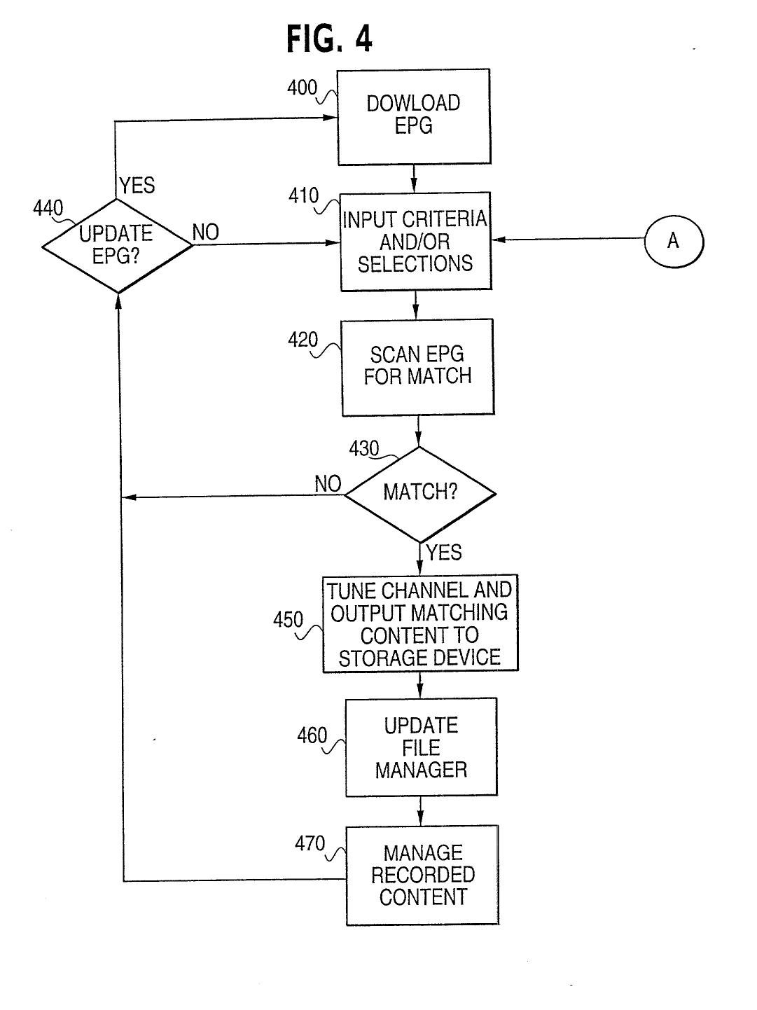

FIG. 4 illustrates further details of how the personalized video-on-demand system of FIG. 1 operates. This process begins in step 400 by downloading the electronic program guide 80. This may be done by utilizing port 82. For example, port 82 may be connected to a telephone line, cable connection, satellite up-link, or radio broadcast antenna. Using any or all of these methods, the information in the electronic program guide 80 may be down-loaded by step 400.

Step 410 then inputs criteria and/or selection(s). This process is described above in relation to FIG. 3 as indicated by connector A. In other words, the FIG. 3 process ends with connector point A which connects this process to the process of FIG. 4.

With the criteria and/or content selection in hand, step 420 can then scan the electronic program guide 80 for matches. In other words, the available content within the electronic program guide 80 is scanned for content matching the user's selections and/or criteria.

Step 430 then determines whether there is a match between the consumer selections and/or criteria and the electronic program guide 80. If there is no match, then the process may continue by proceeding to step 440 which decides whether to update the electronic program guide 80. Preferably, the electronic program guide 80 is updated on a periodic basis. For example, it may be most convenient to update the electronic program guide during off-peak hours. By tracking the user's viewing habits, the system can determine when these off-peak hours occur so that the downloading of the electronic program guide can occur when the consumer is not watching TV. If the electronic program guide 80 is to be updated, then the process proceeds to step 400 which downloads the electronic program guide 80. If not, then the process returns to the input step 410 which inputs the consumer's selections and/or criteria.

If there is a match between the consumer's selections and/or criteria, then the flow proceeds to step 450 which tunes the channel or otherwise outputs the matching content to the storage device. For example, the control unit 70 controls the receiver/tuner 40 to tune the channel of the available content spectrum to the appropriate channel. Then, the switch 50 is controlled by control unit 70 to switch the tuned channel to be fed to the storage device 200. The storage device 200 may then record the routed content.

Once the content has been recorded by storage device 200, step 460 then updates a file manager that may be part of the storage device 250, the control unit 70, other elements of the apparatus 100, or a separate entity. Essentially, the recorded content is stored as a file or files within the storage device 200. These file(s) have an associated address or header information that is managed by the file manager. Step 460 updates the file manager with information related to the recorded content.

By using the file manager, the user can then manage the recorded content with step 470. Specifically, the managing of the recorded content includes sorting, cataloging, adding comments, deleting, reorganizing, etc. Such management may also include on-demand playback. Such playback includes various commands including play, rewind, fast forward, pause, slow, skip, etc. in a manner similar to a video cassette recorder.

The file manager may manage the recorded content by maintaining a data base, containing an entry for each recorded item. The entry may describe the content recorded and identify the memory device (either removable or not) which contains the recorded content. The entry may include all or part of the information received from the electronic program guide. The information received from the electronic program guide may be automatically entered. The entry may also be supplemented by notes or images from the user. The entry may contain alphanumeric characters, images, or both. The file manager may also forward the entry information to the printer 300, either directly from the storage device 200 or via the apparatus 100 (for example, the control unit 70) so that the entry information is printed on a label that can be affixed to the memory device. The file manager may also prompt the user, via user interface 90, to place a self-stick adhesive label in the printer 300.

The user may interface with the file manager via a graphical user interface (GUI), as is known in the art. The GUI allows the user to see what content is available. The GUI also indicates to the user where the content is stored, so the user can manually load the proper medium. As discussed above, alternatively the storage device 200 could automatically load the proper media by using a jukebox arrangement, for example. As discussed previously, the jukebox may include a mixture of blank and recorded media, for example, at least one blank medium for recording and at least one recorded medium for playback.

As is apparent from the above, the database may be populated with information stored in the memory internal to the apparatus 100 or the storage device 200, as well as pre-recorded, removable media, for example, conventional DVDs. It is also possible that user-recorded content, which is stored in the memory internal to the apparatus 100 or the storage device 200, could be saved on removable media. In the instance, it may be advantageous to compress or modify compression parameters to improve the storage efficiency on the removable media. Generally, the apparatus 100 permits the copying or moving of content from internal, non-removable memory to external, removable memory, and vice versa.

The apparatus 100 also supports transcoding from one medium type to another to ensure efficient storage on the target medium. One such example is an initial, user-initiated request to record. The content may be recorded in internal, non-removable memory using one compression technique or set of compression parameters and recorded to an external, removable memory using a different compression technique or set of compression parameters, to thereby improve the storage efficiency of each memory type. In the context of the present specification, the term transcoding or coding is used to identify any type of compression, encryption, reformatting or other manipulation of the information to customize the information for the particular medium on which it is to be stored. After managing the recorded content in step 470, the flow then proceeds to step 440 which decides whether to update the electronic program guide 80 as described in detail above.

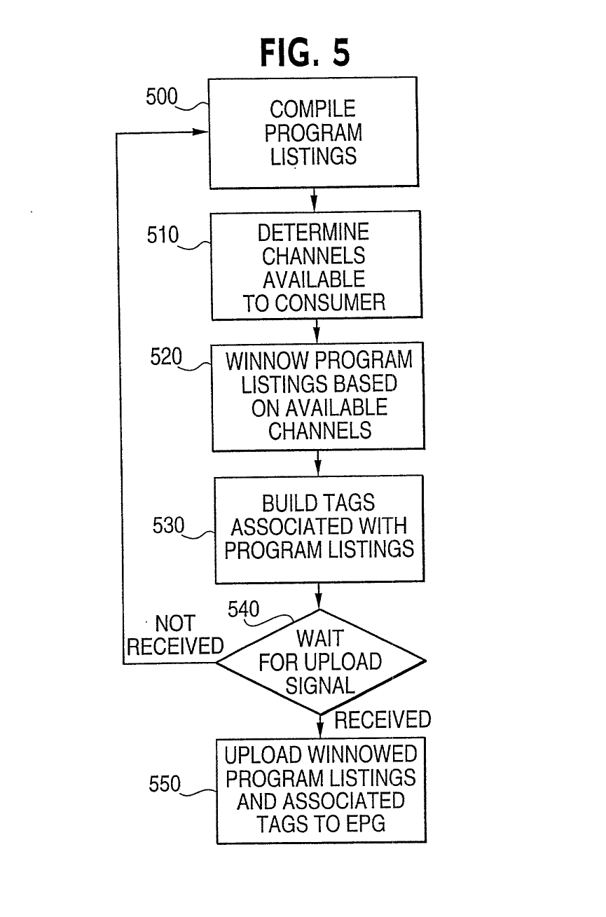

As shown in FIG. 5, the inventive methods also include building the electronic program guide. This process may start with step 500 which compiles the program listings. Such program listings include a channel line-up, names of programs, station information, descriptions of programs, and other information.

Next, step 510 determines which channels are available to the particular consumer. As there are a variety of broadcast systems throughout the world, the channel line-up is different for different consumers. Furthermore, consumers have a choice of broadcast system(s) from which to choose which affects the channels available to the consumer. Step 510 selects from the full spectrum of program listings those channels that are available to the consumer.

Step 520 then winnows the program listings based on the available channels. In other words, the data from step 510 is utilized to winnow the program listings to those that are available to the particular consumer.

Step 530 then builds tags that are associated with the program listings. The tags are described above and will not be repeated here. Step 530 gathers information to build the tags and associates the tags with the program listings.

Then, the system waits for an upload signal. If it has not been received, then the process leaps back to step 500. For example, more information may be available to build or supplement the tags. Also, more channels or less channels may be available to the consumer. All of these considerations are accounted for by looping through steps 500 through 540 until the upload signal has been received.

When the upload signal has been received, then the uploading process begins. Step 550 uploads the winnowed program listings and associated tags to the electronic program guide.

Although FIG. 5 is primarily directed to processes performed by the content feed 10, much of this process could alternatively performed on the consumer side by the apparatus 100. More specifically, the determination of the channels available to the consumer (step 510) and the winnowing of program listings based on available channels (step 520) may be performed on the consumer side by apparatus 100, in one example, by the control unit 70 working in conjunction with the electronic program guide 80 and the storage device 200. In this alternative, the content feed 10 would supply all program listings to the apparatus 100 for determination by the apparatus 100 of the available channels and winnowing of the program listings based on available channels.

As a further alternative, the tag building step 530 may also be performed by the apparatus 100. For example, the control unit 70 may utilize the various communication channels 26, 28, 30, 32 and/or 34 to gather information appropriate for the tags. These tags may then be associated with the corresponding program and stored in the electronic program guide.

The upload signal may be sent by the control unit to the content feed at a specific time, random time, or on command of the user via user interface 90. As mentioned above, it would be most convenient to update the electronic program guide during off-peak hours. By tracking the user's viewing habits, the system can determine when these off-peak hours occur so that the downloading of the electronic program guide can occur when the consumer is not watching TV.

FIG. 2 illustrates an alternative embodiment of the personalized video-on-demand system. This alternative of FIG. 2 is specifically designed for reception/tuning of plural programs, simultaneous recording of two or more programs, as well as simultaneously recording one program while viewing or playing back another program.

Many elements from the first embodiment of FIG. 1 are also utilized in FIG. 2. Common or like reference numerals indicate similar devices and functionality. The FIG. 2 embodiment supports all features described above in conjunction with the FIG. 1 embodiment. Additional features are emphasized below.

The transmitter 21 of content feed 10 is capable of transmitting a plurality of content streams. As further shown in FIG. 2, there are at least two connections each provided to the internet 26, cable 28 and telephone lines 30. Furthermore, the transmitter 22 is capable of broadcasting two or more content streams. Likewise, the satellite up-link 24 is also capable of transmitting two or more content streams.

On the receiving end, the apparatus 110 includes inputs from a first satellite down-link 34 as well as a second satellite down-link 35. These satellite down-links may be integrated into a single satellite down-link having two feeds. In addition, two antennas 32, 33 are utilized. Alternatively, a single connection (satellite down-link, cable, telephone, or internet or antenna) having a split feed could also be utilized instead of the two connections described above. In other words, the connections may be configured to transmit/receive more than one content stream.

As further shown in FIG. 2, the apparatus 110 includes two receivers, specifically receiver/tuner 40 and receiver/tuner 41 which are connected the various communication devices as shown.

The output from receiver/tuners 40, 41 are provided to multiplexer 55. Multiplexer 55 outputs to multiplexer 120 as well as decoder/decrypter 65, storage device 205 and storage device 255. In this way, either or both of the inputs from receivers 40, 41 can be routed to multiplexer 120, decoder/decrypter 65, or storage devices 205, 255.

The decoder/decrypter 65 receives inputs from multiplexer 55 as well as storage devices 205, 255. The outputs of the decoder/decrypter are provided to the multiplexer 120.

Multiplexer 120 receives inputs from multiplexer 55 and decoder/decrypter 65. The output of multiplexer 120 is provided to first display unit 271 and second display unit 272.

The decoder/decrypter 65 is similar to the decoder/decrypter 60 of the FIG. 1 embodiment, with the main difference being that decoder/decrypter 65 is capable of handling a plurality of content streams. In other words, the decoder/decrypter 65 may simultaneously decode and/or decrypt more than one content stream.

The electronic program guide 85 is connected to the control unit 75, the user interface 95 and an input port 82. The electronic program guide (EPG) 85 is similar to the electronic program guide (EPG) 80 of the first embodiment except that the EPG 85 may handle a plurality of content streams. For example, the EPG 85 may be a combination of two EPGs 80.

Similarly, the user interface 95 permits the user to enter commands for both of the content streams rather than the single content stream handled by the first embodiment of FIG. 1.

The control unit 75 has control outputs to the receiver/tuners 40, 41; the multiplexer 55; the decoder/decrypter 65; the EPG 85; the user interface 95; the multiplexer 120; and the storage devices 205, 255.

The storage device 205 is similar to storage device 200 of the first embodiment, but is preferably equipped with a plurality of read/write units. In other words, a storage device 205 is preferably capable of simultaneously recording and/or playing back at least two programs.

An optional, second storage device 255 may also be provided as further shown in FIG. 2. This optional second storage device is connected to the first storage device 205 as well as to multiplexer 55 and decoder/decrypter 65.

The storage devices 205, 255 are preferably modular units that can be expanded by adding additional units therein. For example, if hard disk drives are used for the storage devices 205, 255 then the storage capacity can be expanded by adding additional hard disk drive units. Also, the same variety of storage media may be utilized for the storage devices 205, 255 as described in relation to the storage device 200, 250 of the first embodiment.

The embodiment of FIG. 2 generally operates as follows. For further details on an exemplary method of operation, further reference is made to FIG. 6 which is explained below in detail.

As mentioned above, a plurality of content streams may be fed the apparatus 110 of the second embodiment. For example, two simultaneous content streams can be provided to the receiver/tuners 40, 41. The multiplexer 55 can switch either or both of these content streams and provide the output to various devices.

If recording is desired, then the control unit 75 directs the multiplexer 55 to switch the content from receiver/tuners 40, 41 to the storage device 205. In this way, two programs from two separate content streams can be simultaneously recorded by the storage device 205. Alternatively, one of the programs can be fed to storage device 205 while the other is fed to storage device 255.

If simultaneous record and playback is desired, then control unit 75 directs one of the content streams from receiver/tuner 40, 41 to the storage device 205 by sending a control signal to multiplexer 55. At the same time, the control unit 75 can control the storage device 205 or 255 to playback another program previously recorded therein which is fed from the storage device 205 or 255 to decoder/decrypter 65 arid then to multiplexer 120. Further control can then be exercised by control unit 75 which can control multiplexer 120 to feed the playback or record program to either or both display units 271, 272.

The display units 271, 272 may be separate display devices or may be integrated in a single display device. For example, conventional picture-in-picture display devices can handle two simultaneous input streams and such a device is within the scope of this invention.

If simultaneous playback of two programs is desired, then control unit 75 controls the storage devices 205 and/or 255 to simultaneously playback two previously recorded programs. These programs are fed through decoder/decrypter 65 into multiplexer 120. Preferably, control unit 75 would then control multiplexer 120 to switch one of the programs to the first display unit number 271 while the other is directed to the second display unit 272.

If the user wants to view a live broadcast while recording another program, then the control unit 75 operates as follows. In this example, it is assumed that the live program to be viewed is being received by the first receiver/tuner 40. Control unit 75 then sends a control signal to multiplexer 55 to route the live broadcast program to either the multiplexer 120 or the decoder/decrypter 65. This decision is made depending on whether the live broadcast requires decoding and/or decryption. Depending upon which display unit is intended for viewing, the control unit 75 controls the multiplexer 120 to route the decoded and/or decrypted content to the appropriate display unit 271, 272. If no decryption or decoding is necessary, then control unit 75 directs the multiplexer 55 to route the content directly to multiplexer 120 which can then send the live broadcast to either of the display units 271, 272.

If the consumer wants to see two live broadcasts with no recording, then the control unit 75 controls multiplexer 55 to route both received content streams to either decoder/decrypter 65 or to multiplexer 120 depending upon whether decryption and/or decoding is necessary. Thereafter, the displays can be switched by multiplexer 120 under the control unit 75 to the appropriate displays 271, 272.

As can be seen from the above description, the FIG. 2 embodiment is highly advantageous and permits a variety of functions. For example, a user can simultaneously record at least two content streams on the storage devices 205 or 255. In this way, the video-on-demand library can be quite rapidly accumulated.

Furthermore, the FIG. 2 embodiment permits the simultaneous viewing of one program while another is being recorded. In this way, a consumer can watch his television in the normal manner while still accumulating a video-on-demand library in the background. When the live television broadcast gets boring or is no longer interesting, then the user can switch to the video-on-demand library that has been accumulating during his viewing or at other times.

Furthermore, the electronic program guide 85 permits a user to navigate the plurality of desired content, make appropriate selections and build the video-on-demand library that most suits his needs.

FIG. 6 further illustrates some of the methods utilized by the second embodiment. Generally speaking, FIG. 6 resolves scheduling conflicts between two or more programs.

More specifically, the process of FIG. 6 begins by scanning the electronic program guide 85 for a match. This is similar to the process described in relation to step 430 in FIG. 4. One difference is that step 600 may scan for more than one match.

Step 610 determines if there is at least one match. If not, then the process loops back to step 600. If there is at least one match, then the flow proceeds to step 620 which determines whether there is a scheduling conflict. More specifically, step 620 determines whether the recording of one program matching the consumer's desires would overlap with the recording of another program matching the consumer's desires.

If there is no conflict, then the flow proceeds to step 630 which records the matching content. Thereafter, the file manager is updated in a manner similar to step 460 in FIG. 4 and the flow proceeds to step 670 which is described below.

If there is a conflict, then step 650 performs multiple recording of the plurality of programs matching the consumer's desires. This process is generally described above and utilizes the control unit 75 to switch the desired content through multiplexer 55 to the storage devices 205 or 255. The switching is controlled on a scheduled basis according to the time schedule of each program. Multiple recording continues as long as there is an overlap between the schedules.

Step 660 determines whether all recording has finished. If so, then the file manager is updated in step 640 which process is described above.

If all recording has not been finished, then a further decision is made in step 670 to determine whether there is one or more recording to be completed. If so, then the process loops back to step 600 which again scans the electronic program guide 85 for another match. In this way, the system can continue recording at least two programs simultaneously.

Although the above description relates to recording two programs simultaneously, the embodiment of FIG. 2 can be extended to record three or more programs simultaneously. Essentially, the components of FIG. 2 would be multiplied such that there would be N receivers/tuners and the storage devices would be capable of recording N programs simultaneously.

Although most of the specification is directed to devices and methods for handling video content, the invention also applies to audio content, data content or mixed content. In other words, the content feed may supply audio or data content to the apparatus 100 or 110.

For example, the decoder/decrypter 60, 65 could be reconfigured to decode and/or decrypt audio data. In addition, the MPG 3 standard, the Windows Media Audio (WMA) standard or other conventional decoding schemes as well as conventional decrypting schemes may be utilized by decoder/decrypter 60, 65 to decode and/or decrypt the audio content. Furthermore, the display units 270, 271, 272 would be speakers or other audio reproduction devices instead of video display units in this alternative. Otherwise, the systems and methods of the invention would work in much the same manner to aggregate an audio-on-demand library.

In at least one embodiment described above, the present invention contemplates the concurrent use of internal, non-removable memory and external, removable memory. In at least one embodiment described above, the present invention also contemplates recording content in an internal, non-removable memory prior to recording in an external, removable memory, where the recording to the external, removable memory can occur in a background mode. In at least one embodiment described above, the present invention also contemplates recording content by streaming directly to the removable medium. In at least one embodiment described above, the present invention also contemplates playing back by recording from the external, removable memory into the internal, non-removable memory and then playing back from the internal, non-removable memory. As mentioned above, the invention may also be applied to aggregate desired data. If data is being aggregated by the present invention, then the system may be labeled a personal data server farm. For example, a personal data server farm according to the invention may aggregate a data-on-demand library such as a library of desired usenet news. The consumer could designate usenet newsgroups that interest that user using the user interface 90 and, perhaps an electronic program guide 80 and the system would then aggregate a library of usenet news. This aggregated library of data may then be manipulated on-demand of the user. Various other types of data may be aggregated by the invention with usenet news being only an illustrative example. If the invention is being applied to aggregate data content, then the decoding and/or decrypting schemes may utilize schemes appropriate to decoding and/or decrypting data. Furthermore, if the data is being broadcast according to a schedule then the scheduling and scheduling conflict resolution features described above in terms of audio data may be applied to such broadcast data.

Furthermore, the inventive apparatus 100,110 may be embodied in a variety of ways. A set-top box is one example. Other examples include a personal computer (PC), TV or hardware card that is added to an existing apparatus such as a conventional set-top box, PC or TV. Still further, the inventive functionality may be downloaded or otherwise programmed into a set-top box, PC or TV. Such programming may be accompanied by connecting the programmed device to a storage device such as hard disc drive array 200. Furthermore, although FIGS. 1 and 2 illustrate electronic program guides 80,85 as part of the apparatus 100,110, the electronic program guide content could also be provided by the content feed 10.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

What is claimed is:

1. A method of creating a personalized video-on-demand service, comprising:
receiving an electronic program guide with available content;
receiving preferences indicating potentially desired content;
scanning the electronic program guide for the potentially desired content;
recording the potentially desired content located by said scanning;
aggregating a library of potentially desired content by iterating said scanning and recording steps;
creating a database, which catalogs the potentially desired content;
selecting content from the database and permitting on-demand viewing of the selected content from the library of potentially desired content by a user.

2. The method of creating a personalized video-on-demand service according to claim 1, further comprising:
determining a schedule of the potentially desired content; and
resolving conflicts in the schedule;
said recording step recording the potentially desired content according to the resolved schedule.

3. The method of creating a personalized video-on-demand service according to claim 1, further comprising:
permitting a user to edit the library of potentially desired content.

4. The method of creating a personalized video-on-demand service according to claim 1, further comprising:
permitting a user to organize the library of potentially desired content.

5. The method of creating a personalized video-on-demand service according to claim 1, further comprising:
permitting a user to add at least one comment to at least one portion of the library of potentially desired content.

6. The method of creating a personalized video-on-demand service according to claim 1, further comprising:
waiting until the potentially desired content is about to be broadcast,
said recording step synchronizing the recording according to said waiting step.

7. The method of creating a personalized video-on-demand service according to claim 1, said inputting including inputting criteria indicating one or more potentially desired content.

8. The method of creating a personalized video-on-demand service according to claim 1, said inputting including determining potentially desired content selections based on previously selected content.

9. The method of creating a personalized video-on-demand service according to claim 1, wherein said recording step is performed on at least one storage medium.

10. The method of creating a personalized video-on-demand service according to claim 9, wherein the at least one storage medium is reconfigurable.

11. The method of creating a personalized video-on demand service according to claim 9, wherein the at least one storage medium is removable.

12. The method of creating a personalized video-on-demand service, according to claim 9, further comprising synchronizing access of the at least one storage medium to avoid periods of inaccessibility.

13. The method of creating a personalized video-on-demand service, according to claim 9 further comprising, providing a synch pulse to confirm availability of the at least one storage medium.

14. The method of creating a personalized video-on demand service according to claim 9, wherein the at least one storage medium is expandable.

15. The method of creating a personalized video-on-demand service according to claim 9, wherein at least one storage medium is integrated or accessible via network.

16. The method of creating a personalized video-on-demand service according to claim 9, wherein at least one storage medium is automatically loaded.

17. The method of creating a personalized video-on-demand service according to claim 9, wherein the at least one storage medium is magnetic tape, magnetic or optical disk (for example, a read/write disk or a write one/read many disk), CD, DVD, a portable digital audio/video/ data player or a jukebox.

18. The method of creating a personalized video-on-demand service according to claim 9, wherein the at least one storage medium includes at least one integrated storage medium and at least one removable storage medium.

19. The method of creating a personalized video-on-demand service according to claim 18, wherein the potentially desired content may be recorded or played back via the at least one integrated storage medium, the at least one removable storage medium, or both.

20. The method of creating a personalized video-on-demand service according to claim 18, further comprising coding the potentially desired content, depending on the type of medium on which the potentially desired content will be stored.

21. The method of creating personalized video-on-demand service according to claim 19, wherein the potentially desired content is streamed directly to the at least one removable storage medium.

22. The method of creating a personalized video-on-demand service, according to claim 21, wherein the potentially desired content may be stored or recorded in at least one removable storage medium at faster or slower than normal speed.

23. The method of creating personalized video-on-demand service according to claim 9, wherein the database contains an entry for each program recorded on the at least one storage medium.

24. The method of creating personalized video-on-demand service according to claim 9, wherein the database is manipulated by the user via a graphical user interface.

25. The method of creating personalized video-on-demand service according to claim 23, wherein each entry describes the program with which it is associated.

26. The method of creating personalized video-on-demand service according to claim 25, wherein each entry includes at least one of text and image information.

27. The method of creating personalized video-on-demand service according to claim 26, wherein the image information is one of a thumbnail, a preview, and a snippet.

28. The method of creating personalized video-on-demand service according to claim 23, further comprising:
printing at least part of the entry on a label affixable to the at least one storage medium.

29. The method of creating a personalized video-on-demand service, according to claim 9, wherein the potentially desired content includes a first content and a second content, said method further comprising:
simultaneously recording the first content and the second content.

30. The method of creating a personalized video-on-demand service, according to claim 9, wherein the potentially desired content includes a first content, a second content and a third content, said method further comprising:
determining whether the recording of the first content has been completed;
simultaneously recording the second and the third content.

31. The method of creating a personalized video-on-demand service, according to claim 9, wherein the potentially desired content includes a first content and a second content, said method further comprising:
performing on demand play back of the first and/or second content simultaneous with the recording of the first and/or second content; and
performing on demand play back of the second and/or third content simultaneous with the recording of the second and/or third content.

32. A method of aggregating content in a personal audio/video server farm, comprising:
determining potentially desired content;
scanning available content for content matching the potentially desired content;
receiving the available content from a content source;
recording the potentially desired content on a personal audio/video server farm;
creating a database, which catalogs the potentially desired content; and
iterating the method to build an aggregation of potentially desired content on the personal audio/video server farm.

33. The method of aggregating content in a personal audio/video server farm according to claim 32, said determining step determining the potentially desired content from an electronic program guide.

34. The method of aggregating content in a personal audio/video server farm according to claim 32, said receiving including receiving broadcast content.

35. The method of aggregating content in a personal audio/video server farm according to claim 32, further comprising:
on-demand viewing selected content from the aggregation of potentially desired content stored in the personal audio/video server farm.

36. The method of aggregating content in a personal audio/video server farm according to claim 32, further comprising:
adding storage capacity to the personal audio/video server farm in which to build the aggregation of potentially desired content.

37. The method of aggregating content in a personal audio/video server farm according to claim 32, wherein at least a portion of the available content is encrypted, the method further comprising:
decrypting the selected, encrypted content;
on-demand viewing selected, decrypted content from the aggregation of potentially desired content stored in the personal audio/video server farm.

38. The method of aggregating content in a personal audio/video server farm according to claim37, further comprising:
purchasing a decryption authorization to enable said decrypting step.

39. The method of aggregating content in a personal audio/video server farm according to claim 38, wherein said purchasing step is performed after said receiving step.

40. The method of creating a personalized video-on-demand service according to claim 32, wherein said recording step is performed on at least one storage medium.

41. The method of creating a personalized video-on-demand service according to claim 40, wherein the at least one storage medium is reconfigurable.

42. The method of creating a personalized video-on demand service according to claim 40, wherein the at least one storage medium is removable.

43. The method of creating a personalized video-on-demand service, according to claim 40, further comprising synchronizing access of the at least one storage medium to avoid periods of inaccessibility.

44. The method of creating a personalized video-on-demand service, according to claim 40 further comprising, providing a synch pulse to certain availability of the at least one storage medium.

45. The method of creating a personalized video-on demand service according to claim 40, wherein the at least one storage medium is expandable.

46. The method of creating a personalized video-on-demand service according to claim 40, wherein the at least one storage medium is integrated or accessible via network.

47. The method of creating a personalized video-on-demand service according to claim 40, wherein the at least one storage medium is automatically loaded.

48. The method of creating a personalized video-on-demand service according to claim 40, wherein at least one the storage medium is magnetic tape, magnetic or optical disk (for example, a read/write disk or a write one/read many disk), CD, DVD, a portable digital audio/video/data player or a jukebox.

49. The method of creating a personalized video-on-demand service according to claim 40, wherein the at least one storage medium includes at least one integrated storage medium and at least one removable storage medium.

50. The method of creating a personalized video-on-demand service according to claim 49, wherein the potentially desired content may be recorded or played back via the at least one integrated storage medium, the at least one removable storage medium, or both.

51. The method of creating a personalized video-on-demand service according to claim 49, further comprising coding the potentially desired content, depending on the type of medium on which the potentially desired content will be stored.

52. The method of creating personalized video—on-demand service according to claim 50, wherein the potentially desired content is streamed directly to the at least one removable storage medium.

53. The method of creating a personalized video-on-demand service, according to claim 52, wherein the potentially desired content may be stored or recorded in at least one removable storage medium at faster or slower than normal speed.

54. The method of creating personalized video-on-demand service according to claim 40, wherein the database contains an entry for each program recorded on the at least one storage medium.

55. The method of creating personalized video-on-demand service according to claim 40, wherein the database is manipulated by the user via a graphical user interface.

56. The method of creating personalized video-on-demand service according to claim 54, wherein each entry describes the program with which it is associated.

57. The method of creating personalized video-on-demand service according to claim 56, wherein each entry includes at least one of text and image information.

58. The method of creating personalized video-on-demand service according to claim 57, wherein the image information is one of a thumbnail, preview, and snippet.

59. The method of creating personalized video-on-demand service according to claim 54, further comprising:
printing at least part of the entry on a label affixable to the at least one storage medium.

60. The method of creating a personalized video-on-demand service, according to claim 40, wherein the potentially desired content includes a first content and a second content, said method further comprising:
simultaneously recording the first content and the second content.

61. The method of creating a personalized video-on-demand service, according to claim 40, wherein the potentially desired content includes a first content, a second content and a third content, said method further comprising:
determining whether the recording of the first content has been completed;
simultaneously recording the second and the third content.

62. The method of creating a personalized video-on-demand service, according to claim 40, wherein the potentially desired content includes a first content and a second content, said method further comprising:
performing on demand play back of the first and/or second content simultaneous with the recording of the first and/or second content; and
performing on demand play back of the second and/or third content simultaneous with the recording of the second and/or third content.

63. A system for creating a personal video on-demand service, comprising:
a receiving device operatively connected to a content feed;
at least one storage medium operatively connected to said receiving device;
said receiving device receiving an electronic program guide, said electronic program guide indicating a plurality of available content to be broadcast to said receiving device via the content feed;
a control unit operatively connected to said at least one storage medium;
said control unit determining potentially desired content by scanning the electronic program guide for content matching user preferences;
said control unit controlling said at least one storage medium to record the potentially desired content to create an on-demand video library;
said control unit creating a database which catalogs the potentially desired content;
a user input device operatively connected to said control unit, said user input device permitting a user to interact with the database and enter play-back commands,
said control unit playing back one or more of the recorded content from said at least one storage medium on demand from the user in response to the play-back commands from said user input device.

64. The system for creating a personal video on-demand service according to claim 63, further comprising:
a display device operatively connected to said at least one storage medium, said display device receiving the played-back content from said at least one storage medium and displaying the played-back content.

65. The system for creating a personal video on-demand service according to claim 63,
said receiving device and said control unit being provided in a unit,
said at least one storage medium external to the unit and operatively connected to the unit.

66. The system for creating a personal video on-demand service according to claim 63, wherein said at least one storage medium is expandable so as to accommodate a larger video library.

67. The system for creating a personal video on-demand service according to claim 63, said at least one storage medium including a plurality of modular storage devices operatively connectable to said receiving device.

68. The system for creating a personal video on-demand service according to claim 63, wherein the content feed supplies content in an encrypted form and said at least one storage medium stores the desired content in the encrypted form, the system further comprising:
a decryption unit operatively connected to said at least one storage medium, said decryption unit decrypting the desired content supplied from said storage device.

69. The system for creating a personal video on-demand service according to claim 63, wherein the content feed supplies content in an encrypted form and said at least one storage medium stores the desired content in the encrypted form, the apparatus further comprising:
a switching device operatively connected to said receiving device, said at least one storage medium and said control unit;
a decryption unit operatively connected to said switching device and to said at least one storage medium, said decryption unit decrypting the desired programs supplied from said at least one storage medium;
wherein said control device controls said switching device to route the encrypted content to either said at least one storage medium or to said decryption unit.

70. The system for creating a personal video on-demand service according to claim 63, said electronic program guide including a port that receives program guide information.

71. The system for creating a personalized video-on-demand service according to claim 63, wherein the at least one storage medium is reconfigurable.

72. The system for creating a personalized video-on demand service according to claim 71, wherein the at least one storage medium is removable.

73. The system for creating a personalized video-on-demand service, according to claim 71, further comprising synchronizing access of the at least one storage medium to avoid periods of inaccessibility.

74. The system for creating a personalized video-on-demand service, according to claim 71 said system, providing a synch pulse to confirm availability of the at least one storage medium.

75. The system for creating a personalized video-on demand service according to claim 71, wherein the at least one storage medium is expandable.

76. The system for creating a personalized video-on-demand service according to claim 71, wherein the at least one storage medium is integrated or accessible via network.

77. The system for creating a personalized video-on-demand service according to claim 71, wherein the at least one storage medium is automatically loaded.

78. The system for creating a personalized video-on-demand service according to claim 71, wherein the at least one storage medium is magnetic tape, magnetic or optical disk (for example, a read/write disk or a write one/read many disk), CD, DVD, a portable digital audio/video/data player, or a jukebox.

79. The system for creating a personalized video-on-demand service according to claim 71, wherein the at least one storage medium includes at least one integrated storage medium and at least one removable storage medium.

80. The system for creating a personalized video-on-demand service according to claim 79, wherein the potentially desired content may be recorded or played back via the at least one integrated storage medium, the at least one removable storage medium, or both.

81. The system for creating a personalized video-on-demand service according to claim 79, said control unit further coding the potentially desired content, depending on the type of medium on which the potentially desired content will be stored.

82. The system for creating personalized video-on-demand service according to claim 80, wherein the potentially desired content is streamed directly to the at least one removable storage medium.

83. The system for creating a personalized video-on-demand service, according to claim 71, wherein the potentially desired content may be stored or recorded in at least one removable storage medium at faster or slower than normal speed.

84. The system for creating personalized video-on-demand service according to claim 71, wherein the database contains an entry for each program recorded on the at least one storage medium.

85. The system for creating personalized video-on-demand service according to claim 71, wherein the database is manipulated by the user via a graphical user interface.

86. The system for creating personalized video-on-demand service according to claim 84, wherein each entry describes the program with which it is associated.

87. The system for creating personalized video-on-demand service according to claim 86, wherein each entry includes at least one of text and image information.

88. The system for creating personalized video-on-demand service according to claim 87, wherein the image information is one of a thumbnail, preview, and snippet.

89. The system for creating personalized video-on-demand service according to claim 87, further comprising:
a printer for printing at least part of the entry on a label affixable to the at least one storage medium.

90. The system for creating a personalized video-on-demand service, according to claim 71, wherein the potentially desired content includes a first content and a second content, and said system simultaneously records the first content and the second content.

91. The system for creating a personalized video-on-demand service, according to claim 71, wherein the potentially desired content includes a first content, a second content and a third content, and said system determines whether the recording of the first content has been completed, and simultaneously records the second and the third content.

92. The system of creating a personalized video-on-demand service, according to claim 71, wherein the potentially desired content includes a first content and a second content, and said system performs on demand play back of the first and/or second content simultaneous with the recording of the first and/or second content; and performs on demand play back of the second and/or third content simultaneous with the recording of the second and/or third content.

93. A system for creating a personal video on-demand service, comprising:
a plurality of receiving devices each of which is operatively connected to one or more content feeds;
at least one storage medium operatively connected to said receiving devices;
said receiving device receiving an electronic program guide, said electronic program guide indicating a plurality of desired content to be broadcast to said receiving devices via the content feed;
a control unit operatively connected to said at least one storage medium;
said control device recording the desired programs indicated by said electronic program guide in said at least one storage medium to create an on-demand video library;
said control unit creating a database which catalogs the potentially desired content;
a user input device operatively connected to said control unit, said user input device permitting a user to interact with the database enter play-back commands,
said control unit playing back one or more of the recorded programs from said at least one storage medium on demand from the user in response to the play-back commands from said user input device.

94. The system for creating a personal video on-demand service according to claim 93, further comprising:
a decrypter device;
a first switching device operatively connected to said receiving devices, said at least one storage medium, said decrypter device and said control unit, said first switching device switching content from said receiving devices to said at least one storage medium or said decrypter device in response to a control signal from said control unit.

95. The system for creating a personal video on-demand service according to claim 93, further comprising:
a first and a second display device; and
a second switching device operatively connected to said first switching device, said decrypter device, said first display device and said second display device,
said second switching device switching content from said first switching device and/or said decrypter device to said first display device and/or said second display device.

96. The system for creating a personal video on-demand service according to claim 93, wherein said at least one storage device includes a first and a second storage medium, the system further comprising:
a first switching device operatively connected to said receiving devices, said first storage medium, said second storage medium and said control unit, said first switching device switching content from said receiving devices to said first storage medium and/or said second storage medium in response to a control signal from said control unit.

97. The system for creating a personal video on-demand service according to claim 96,
said control unit identifying scheduling conflicts between the recording or playing back of two or more content selections,
said control unit resolving the identified scheduling conflicts by controlling said first switching device.

98. The system for creating a personal video on-demand service according to claim 93, said electronic program guide including a port that receives program guide information.

99. The system for creating a personal video-on-demand service according to claim 93, wherein the at least one storage medium is reconfigurable.

100. The system for creating a personal video-on demand service according to claim 93, wherein the at least one storage medium is removable.

101. The system for creating a personal video-on-demand service, according to claim 93, said system synchronizing access of the at least one storage medium to avoid periods of inaccessibility.

102. The system for creating a personal video-on-demand service, according to claim 93 said system, providing a synch pulse to confirm availability of the at least one storage medium.

103. The system for creating a personal video-on demand service according to claim 93, wherein the at least one storage medium is expandable.

104. The system for creating a personal video-on-demand service according to claim 93, wherein the at least one storage medium is integrated or accessible via network.

105. The system for creating a personal video—on-demand service according to claim 93, wherein the at least one storage medium is automatically loaded.

106. The system for creating a personal video-on-demand service according to claim 93, wherein the at least one storage medium is magnetic tape, magnetic or optical disk (for example, a read/write disk or a write one/read many disk), CD, DVD, a portable digital audio/video/data player, or a jukebox.

107. The system for creating a personal video-on-demand service according to claim 93, wherein the at least one storage medium includes at least one integrated storage medium and at least one removable storage medium.

108. The system for creating a personal video-on-demand service according to claim 107, wherein the potentially desired content may be recorded or played back via the at least one integrated storage medium, the at least one removable storage medium, or both.

109. The system for creating a personal video-on-demand service according to claim 93, said control unit further coding the potentially desired content, depending on the type of medium on which the potentially desired content will be stored.

110. The system for creating personal video-on-demand service according to claim 108, wherein the potentially desired content is streamed directly to the at least one removable storage medium.

111. The system for creating a personal video-on-demand service, according to claim 93, wherein the potentially desired content may be stored or recorded in at least one removable storage medium at faster or slower than normal speed.

112. The system for creating personal video-on-demand service according to claim 93, wherein the database contains an entry for each program recorded on the at least one storage medium.

113. The system for creating personal video-on-demand service according to claim 93, wherein the database is manipulated by the user via a graphical user interface.

114. The system for creating personal video-on-demand service according to claim 112, wherein each entry describes the program with which it is associated.

115. The system for creating personal video-on-demand service according to claim 114, wherein each entry includes at least one of text and image information.

116. The system for creating personal video-on-demand service according to claim 115, wherein the image information is one of a thumbnail, preview, and snippet.

117. The system for creating personal video-on-demand service according to claim 112, further comprising:
a printer for printing at least part of the entry on a label affixable to the at least one storage medium.

118. The system for creating a personal video-on-demand service, according to claim 93, wherein the potentially desired content includes a first content and a second content, and said system simultaneously records the first content and the second content.

119. The system for creating a personal video-on-demand service, according to claim 93, wherein the potentially desired content includes a first content, a second content and a third content, said system determining whether the recording of the first content has been completed and simultaneously recording the second and the third content.

120. The system for creating a personal video—on-demand service, according to claim 93, wherein the potentially desired content includes a first content and a second content, said system further performing on demand play back of the first and/or second content simultaneous with the recording of the first and/or second content; and performing on demand play back of the second and/or third content simultaneous with the recording of the second and/or third content.
